(19) United States
(12) Patent Application Publication
(10) Pub. No.: US 2017/0195729 A1
(43) Pub. Date: Jul. 6, 2017

(54) METHOD TO OPTIMIZE THE TRANSMISSION OF A SET OF TELEVISION CHANNELS

(71) Applicant: NAGRAVISION S.A., Cheseaux-sur-Lausanne (CH)

(72) Inventor: Salvatore BOCCHETTI, Lausanne (CH)

(73) Assignee: NAGRAVISION S.A., Cheseaux-sur-Lausanne (CH)

(21) Appl. No.: 15/128,903

(22) PCT Filed: Mar. 26, 2015
(86) PCT No.: PCT/EP2015/056640

§ 371 Date: Sep. 23, 2016

(30) Foreign Application Priority Data
Mar. 26, 2014 (EP) 14161759.7

(51) Int. Cl. H04N 21/462; H04N 21/2385; H04N 21/266; H04N 21/61

(52) U.S. Cl. CPC H04N 21/4622; H04N 21/6125; H04N 21/2385; H04N 21/6175; H04N 21/6143; H04N 21/266

(57) ABSTRACT

A method to optimize transmission of a set of television channels to a reception device having at least a broadcast interface and an IP interface, comprising: selecting by a reception device a channel having a channel identifier received via either the broadcast communication means from a broadcast transmission center or the IP communication means from an IP transmission center; transmitting by the reception device to a control center a status message comprising at least the selected channel; receiving, by the control center, status messages from a plurality of reception devices; calculating by the control center, a cost per channel based at least on the number of reception devices selecting said channel; allocating the channels having the highest cost to the broadcast transmission center and allocating the other channels to the IP transmission center; and transmitting to the reception devices an allocation list describing to which interface each channel was allocated.

### INTRODUCTION

Today, reception devices for television programs are able to receive media contents from a plurality of sources. Hybrid Broadcast Broadband TV (HbbTV) is both an industry standard (ETSI TS 102 796) and promotional initiative for hybrid digital TV to harmonise the broadcast, IPTV, and broadband delivery of entertainment content to the end consumer through connected TVs (smart TVs) and set-top boxes. The HbbTV consortium, regrouping digital broadcasting and Internet industry companies, establishes a standard for the delivery of broadcast TV and broadband TV to the home, through a single user interface, creating an open platform as an alternative to proprietary technologies. Products and services using the HbbTV standard can operate over different broadcasting technologies, such as satellite, cable or terrestrial networks.

HbbTV allows for digital television content from a number of different sources to be shown including traditional broadcast TV, Internet, and connected devices in the home. To watch hybrid digital TV, consumers will need a hybrid IPTV set-top box with a range of input connectors including Ethernet, as well as at least one tuner for receiving broadcast TV signals. The tuner in a hybrid set-top box can be digital terrestrial television (DVB-T, DVB-T2), digital cable (DVB-C, DVB-C2) or digital satellite (DVB-S, DVB-S2) compatible.

As a consequence, the hybrid IPTV set-top box has the choice of activating a broadcast communication means or an IP communication means to obtain the channel requested by the user. By broadcast communication, we understand the transmission of the same content to many devices, via the cable, the satellite, or radio waves antenna. This also includes multicast over IP, in which a particular content is available on an IP network and can be accessed at the same time by a plurality of devices (one to many). By IP communication, we understand the transmission on request by a device via an IP network (one to one). This choice should be transparent for the user and the reception device should determine which communication means is available for a given channel and in case the channel is available on both communication means, the quality available on each means.

On the transmission side, the cost for rendering a channel accessible is not the same if it is available on broadcast or IP. On broadcast, the bandwidth per channel is usually wider and the decision to include a channel into a broadcast feed is determined by the broadcaster. The setting-up of the feed is more complicated since the allocation of the frequency for a given service should be precisely described in tables (Program Association Table PAT, Program Map Table PMT). These tables describe the content of the different transponders since a service is composed of a plurality of elementary streams (audio, video, data, caption, access control) identified by a Packet Identifier PID and a plurality of services are transmitted by the same transponder. Changing the distribution of these services is therefore cumbersome.

On the other side, IP transmission is simple since the reception device sends a request to an IP transmission center to obtain a given channel. The IP transmission center prepares and sends the requested channel to the reception device using the IP protocol. This channel uses the Internet connection of the user. Dedicated packets, forming the requested channel, are sent to the reception device. The drawback of this solution is the bandwidth which is required since this bandwidth increases linearly with the number of users. It is therefore more advantageous to address a large audience with a broadcast communication. However, with the increase of available channels, the available frequencies and services are not sufficient to satisfy the demand, and some more confidential channels will only be accessible via IP communication. The decision to use one or the other communication means is generally based on audience survey results.

As the demand for different channels evolves with time, there is also a need for a mechanism that enables a flexible modification of the channels made accessible to users from broadcast means to IP means and vice versa

### BRIEF DESCRIPTION OF THE INVENTION

The aim of the present description is to propose a different approach to allocate a channel to either the broadcast communication means or the IP communication means and to allow for a certain amount of flexibility in such allocation.

Accordingly, there is proposed a method to optimize the transmission of a set of television channels to at least a reception device having a device identifier, said reception device having at least a broadcast communication means and IP communication means, this method comprising the steps of:
selecting, by a reception device, a channel having a channel identifier received via either the broadcast communication means from a broadcast transmission center or the IP communication means from an IP transmission center,
transmitting, by the reception device to a control center, a status message comprising at least the selected channel,
receiving, by the control center, status messages from a plurality of reception devices,
calculating by the control center, from the status messages, a cost per channel based at least on the number of reception devices having selected said channel,
allocating the channels having the highest cost to the broadcasting transmission center and allocating the other channels to the IP transmission center,
transmitting a response message to the reception devices, said response message comprising an allocation list describing, for each channel, to which communication means said channel is allocated.

A set of channels (or services according to the DVB recommendation) is delivered to a broadcast transmission center and an IP transmission center. The control center is in charge of allocating the channels to each transmission center. For that purpose, each transmission center has access to all the channels and selects only the one specified by the control center for transmission.

According to one aspect of this method, the control center receives from the reception devices, the channel identifiers of the channels currently in use. This information serves to determine the number of concurrent receptions of one channel are requested and as a consequence, what is the most appropriate way to transmit the channels to the users.

According to another aspect of the invention, there is provided a method for changing the allocation of channels to each transmission center, in a flexible way. In particular, this method allows for a channel which were allocated to the broadcast transmission center to be re-allocated to the IP transmission center and vice versa.

The method also allows for the available bandwidth of the broadcast transmission center to be optimized.

### BRIEF DESCRIPTION OF THE FIGURES

The present invention will be better understood thanks to the enclosed drawings in which:

FIG. 1 illustrates a system in which an embodiment as the present invention may be deployed;

FIG. 2 illustrates a reception device suitable for use in the system of FIG. 1.

### DETAILED DESCRIPTION

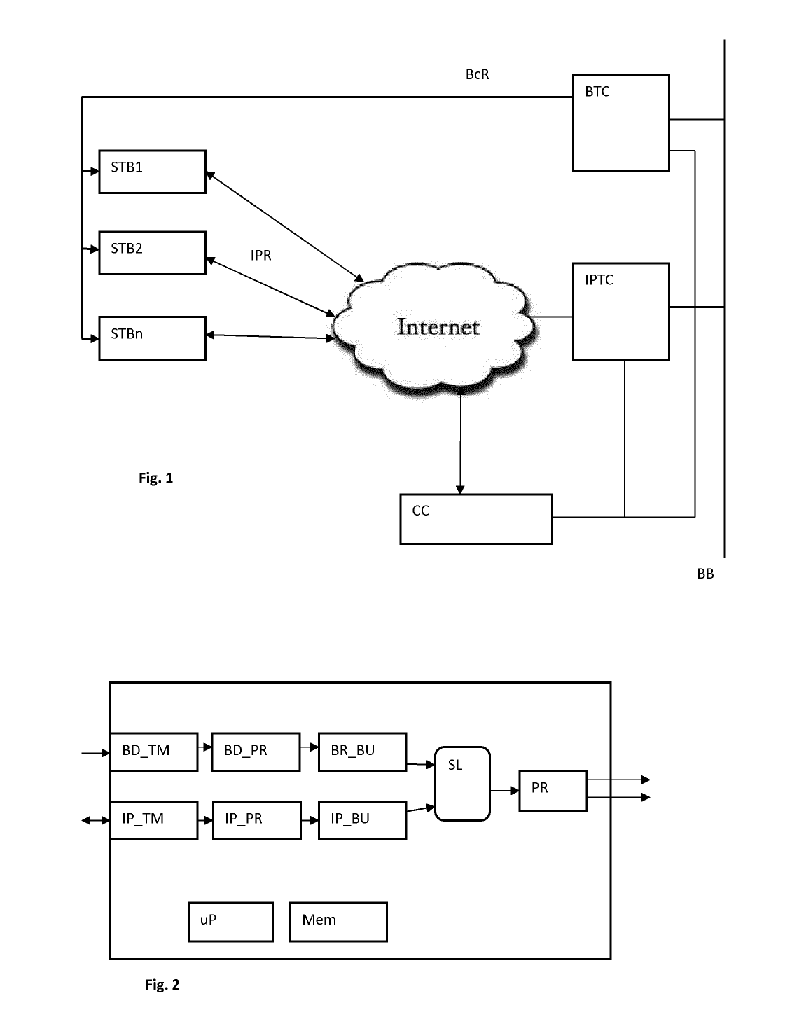

FIG. 1 illustrates the different elements forming a transmission system. On one side, a backbone BB carries all channels available for transmission. This backbone BB is connected to at least one broadcast transmission center BTC and at least one IP transmission center IPTC. It is understood that a plurality of broadcast transmission centers can be used, connected to the backbone, to address a subset of reception devices. This is particularly the case in IP mode, in which an IP transmission center prepares a subset of channels forming an IP channel stream, this stream being transmitted to a local IP transmission front-end in charge of selecting one channel selected by the user and transmitting this channel to the user. These IP transmission front-ends are located close to the users, in particular in the telephone switches or wherever the IP connection of one user is multiplexed.

The transmission system comprises a control center CC whose is to collect the user's behavior and to determine which transmission center is the most appropriate. For this purpose, the control center is connected to Internet and is able to receive messages from and send messages to the reception devices. At the startup of a reception device, a request is sent the control center CC to obtain the list of allocated channels. This list is stored in the reception device and used each time a selection is made by the user. The list contains a description of the transmission means used for a specific channel. The reception device can then select the correct transmission means to receive the channel. According to an embodiment, the list also contains additional details that can speed-up the setting up of the transmission means. In the case of broadcast transmission, the list will contain the transponder identifier, i.e. the central frequency around which the channel is modulated. In the case of IP transmission, the list contains the IP address of the IP transmission center in charge of transmitting this channel.

According to the invention, the reception devices STB1, STB2, STBn communicate the selection made by the user to the control center. This selection comprises at least an identifier of the current main channel or alternatively of a secondary channel such as one currently recorded or in PIP function. A message is generated by a reception device, said message containing an identifier of the current channel and of the other channels currently used, if any. This message can be sent to the control center at each channel change, or at regular intervals (e.g. every 15 min), or on request of the control center.

The control center is in charge of counting the number of reception devices currently using one particular channel. In view of the repetition of the messages sent by the reception devices (in case it is sent every 15 min.) the control center should be able to discard the messages repeating the same information. For that purpose, different solutions are proposed.

A first solution is to associate the message with a unique identification of the reception devices. The control center keeps a table containing, for each unique identification, an identifier of the current channel (Device_ID, Channel). In the case that several channels are used by a single reception device, the message will contain an identifier of each channel used (Device_ID, Channel1, Channel2, Channel3). Once this table is populated, the control center can count the number of times each channel appears. The unique identification can be the unique address of the reception device stored in the reception device and added into the message, or the physical address of the reception device (IP address) obtained by the communication protocol.

Another solution is to use a session number, allocated to a specific reception device by the control center when the reception device first connects to the control center. This session number is valid for a limited time period (e.g. 1 hour) and this time period is updated each time the control center receives a message (Session_ID, Channel) from the reception device. The message may contain this session number allowing the control center to populate the table (Session_ID, Channel, Expiration_Time). In the case that multiple channels are used by a single reception device, the message may contain an identifier of each channel used (Session_ID, Channel1, Channel2, Channel3). Each time a message is received, the expiration time is moved ahead by a predefined value. When the control center counts the entries per channel, it will discard the entries for which the expiration time is behind the current time.

It is also possible not to discard the messages, but on the contrary, to count each message for example over a regular interval, such as 15 minutes. In this case, every 15 minutes, the number of reception devices for each channel is updated and the allocation tables can be updated accordingly.

Thanks to the messages received from the reception devices, the control center can have, for each channel, the number of reception devices currently using said channel. This information is used to calculate a cost per channel, this cost being directly related to the number of reception devices using this channel.

According to a first embodiment, the cost is the number of reception devices. The control center may sort the channels by cost. The channels having the highest costs are then allocated to the broadcast transmission center until the total available bandwidth is full. For example the broadcast transmission center has a capability of 100 MHz. In the allocation to the broadcast transmission center, the bandwidth of each channel will be taken into account. The channels are then sorted by bandwidth, from the ones with the largest bandwidth to the ones with the smallest. The channels are so allocated for broadcast transmission in order to fill the maximum bandwidth (100 MHz). The first channels, the sum of whose cumulated bandwidths does not exceed 100 Mhz are hence broadcast. The other channels are then handled by the IP transmission center. The control center prepares an allocation list describing, for each channel, which transmission center is used. This allocation list is then sent to the reception devices.

In one embodiment, illustrated by the table below, the cost can take into account the bandwidth used by this channel and the number of users accessing it over the Internet (Unicast cost).

| | Number of | | |
|---|---|---|---|
| Channel_ID | customers | Bandwidth | Unicast Cost |
| 27 | 250.000 | 3.5 Mbps | 875k |
| 18 | 135.000 | 4.5 Mbps | 607.5k |
| 134 | 65.000 | 3.5 Mbps | 227k |
| 7 | 60.000 | 5.5 Mbps | 330k |

In the case illustrated above, the unicast cost of the channel 18 can be C_18=135′000×4.5=607.5 k and the unicast cost for the channel 7 is C_7=60′000×5.5=330 k. The sorting of the unicast cost will take into account a combination of the number of devices and the bandwidth. In this case, channel 18 will have a higher cost than channel 7, and for this reason channel 7 will be selected for broadcast with priority over channel 18

This list can take some priority channels into account, i.e. channels which are always sent by one specific transmission means. In the case that a provider has contracted a guarantee with the distributor that a channel will always be sent via broadcast, this channel is always part of the broadcast channels.

In one embodiment, the control center may include a “suboptimal channel” in the list of broadcast channels, when this helps to deal with fractions of bandwidth that would otherwise be wasted. For example, in a system where the maximum bandwidth is 100 Mhz, if the first 19 channels account for 98 Mhz and the 20th channel would occupy 4 Mhz, the control center can decide to broadcast the next channel (e.g. 21^{st} or 22^{nd}, . . . ) whose bandwidth is <=2 Mhz (which is the residual available bandwidth).

The allocation list is established on a regular basis. The section of the list that refers to the broadcast transmission center is sent to the broadcast transmission center and the section that refers to the IP transmission center is sent to the IP transmission center. These transmission centers will then filter the set of channels to keep only the ones mentioned in their respective lists. To facilitate the detection of changes in the allocation list, the same can contain a version indication. Each time the allocation list is changed by the control center, the version indication is updated. This version indication helps the reception devices to detect whether a modification was made compared to the list received previously. If not, the reception device simply ignores the list. When a change occurs in the list, the control center sends this list at least to the reception devices that are currently tuned on one channel affected by a change and to the broadcast and IP transmission centers. It is not desirable that this list change too often. This is why the control center waits a certain time, preferably when a change in the cost ranking is detected, to see if the change is stable or only due to some transient user's behavior. If after a certain time, the cost ranking is stable and one channel should be moved from one transmission means to the other, the control center may decide to change the list.

According to a preferred embodiment, the change occurs in two steps. We take the example of moving the channel A from broadcast transmission means to IP transmission means and the channel B from IP transmission means to broadcast transmission means. The first step is to free one channel on the broadcast transmission center and to copy channel A to the IP transmission center. According to a preferred embodiment, channel A is analyzed to detect content suitable for the transition. A channel usually contains a main section and an auxiliary section. The main section is the user's expected content such as a film, a sport event, a documentary etc. The auxiliary content is mainly the advertisement section. The control center detects the auxiliary section or waits until this happens, to send an allocation list comprising a change. When an auxiliary section is detected, channel A can be changed from broadcast to IP. This is done by sending the updated allocation list to the broadcast transmission center and the IP transmission center. In order to allow for a smooth change, the IP transmission center can be informed first to include channel A into its offer and to keep channel A in the broadcast transmission center. During this transition period, channel A will be available via both transmission means. Concurrently, the updated list is sent to the reception devices, allowing them to change during the auxiliary section of channel A from broadcast to IP.

After this transition period, which can be defined to be long enough to have the time to inform all reception devices, the second step can take place. Channel B is analyzed in order to detect an auxiliary section. Once found, the allocation list is changed and an updated list is sent to the broadcast transmission center to replace channel A by channel B. At that time, if a reception device has not switched to the IP transmission means, it will no longer be able to receive this channel. Once the broadcast center has confirmed that channel B is on air, the control center sends the updated list to the reception devices containing the new allocation for channel B. At that time, the IP center still continues to propose channel B to the reception devices.

After the expiration of the transition phase, the IP transmission center is informed by the control center to deactivate channel B.

In order to make this scenario easier and to minimize the number of communications, the control center could also send the two updated allocation tables together with a validity period (one per list) indicating from when to when each list is valid.

According to a first embodiment, there is no synchronization of the content during or at the end of re-allocation of a channel. Contents of these channels are transmitted and viewed according to the technical constraints of the transmission means.

According to a second embodiment, a synchronization of the content is made during or at the end of the re-allocation of a channel. In this embodiment, the channel contains means for identifying specific places within that content. These means can be for example an index of I-frames, marks that are integrated in the stream or a time-stamp. When a channel is moved from one transmission means to another, the means for identifying a specific place are used to store the place where a channel stopped being transmitted by a specific transmission means. Content is then transmitted by the other transmission means from that stored place. A buffer is preferably integrated in the reception means to store a part of the content and to facilitate the transition between the transmission means. It should be noted that a short part of the content could always be stored, not only during transition.

An allocation list may further comprise additional information. The reception device can send not only the current channel but also the physical reception constraint. In the case that a reception device can only receive a maximum bandwidth of 4 Mbps via IP, moving channel 7 of the list above from broadcast to IP can have a negative consequence for this reception device. The control center may further calculate the impact of this change on the reception devices and in the case that a large number of devices cannot afford this higher bandwidth, may decide to keep channel 7 on the broadcast transmission center even if the number of devices is less than for other channels. For this reason a limit may be set in the control center, for example 10%, so that a change may be blocked if more than 10% of the devices would not be able to follow this change.

It is to be noted that a reception device is not necessarily a set-top box. It can be a computer or even a mobile device. The latter can obtain content via DVB-H (broadcast) or via the data link (3G, 4G or Wifi). Similarly, the content is not necessarily limited to audiovisual content but could be generic data content that could be alternatively broadcast over a satellite or sent over a unicast data link.

FIG. 2 illustrates a reception device in which two transmission means are shown. The IP transmission means IP_TM is in charge of the reception of a channel in IP mode and the data is passed to an IP processing module that produces, for example, a TS packet stream. The same is valid for the broadcast reception means BD_TM, with the received data being passed to a broadcast processing module BD_PR. This module produces a TS packet stream. In the illustrated embodiment, two buffers are shown BP_PU and IP_BU, one per transmission means. The buffers are present to achieve a seamless transition between the two transmission means. It is known that the transmission time is different per transmission means. If one compares the output of the broadcast processing module with the output of the IP processing module, the content can have up to 500 ms difference in time. The buffers will be then used to resynchronize both contents for example by detecting a packet header identifying an I-frame. When the change should occur, the buffer of the other transmission means is analyzed to detect at which position the same packet is present. Once detected, the pointer of the buffer is modified so that both outputs of the processing modules are synchronized. The selection module (SL) can then switch from one source to the other one and pass the content to the decompression module PR.

1. A method to optimize the transmission of a set of television channels to at least one reception device the method comprising the steps of:
selecting, by a reception device having a device identifier, a broadcast interface and Internet Protocol (IP) interface, a channel having a channel identifier received via either the broadcast interface from a broadcast transmission center or the IP interface from an IP transmission center,
transmitting, by the reception device to a control center, a status message comprising at least the selected channel;
receiving, by the control center, status messages from a plurality of reception devices;
calculating, by the control center, from the status messages, a cost per channel based at least on a number of reception devices having selected said channel;
allocating the channels having the highest cost to the broadcast transmission center and allocating the other channels to the IP transmission center; and
transmitting a response message to the reception devices, said response message comprising an allocation list describing, for each channel, to which interface said channel was allocated.

2. The method of claim 1, wherein the transmitted response message comprises the device identifier.

3. The method of claim 1, further comprising the steps of:
prior to selecting a channel, receiving, by the reception device, from the control center, an initialization message comprising the allocation list.

4. The method of claim 3, wherein the initialization message comprises a session number pertaining to one reception device, said session number being added to the status message while the reception device communicates the selected channel.

5. The method of claim 1, wherein the cost is further calculated based on the bandwidth used by the channel.

6. The method of claim 1, wherein the status message comprises an identification of a quality level used by the channel, said cost being calculated for each quality level.

7. The method of claim 1, wherein the response message is sent to each reception device by the broadcast communication center via the broadcast interface.

8. The method of claim 1, wherein the response message is sent to each reception device by the IP communication center via the IP interface.

9. The method of claim 1, wherein the response message is sent only to the reception devices affected by the change.

10. The method of claim 1, wherein if the reception device is receiving the channel via the IP interface and the allocation list contains the broadcast interface for said channel, notifying on a display of the reception of the availability of the same channel on the broadcast interface.

11. The method of claim 1, wherein a media content transmitted through one of the interfaces comprises a main section and an auxiliary section, in the case that the control center allocates a channel to another transmission center, the change of allocation occurs during the transmission of the auxiliary section of the channel.

12. The method according to claim 1, wherein a channel initially allocated to the IP transmission center is reallocated to the broadcast transmission center, said method comprising the steps of:
copying at least one channel initially allocated to the broadcast transmission center, on the IP transmission center, said at least one channel being allocated to both the broadcast transmission center and the IP transmission center during a transition period;
clearing at least one channel on the broadcast transmission center; and
allocating at least one channel to the broadcast transmission center, in the free room.

13. The method of claim 12, wherein, after each step, a new allocation table is sent to the reception devices.

14. The method of claim 12, wherein content of a channel to be reallocated is analyzed to detect an auxiliary section and wherein the channel is changed from broadcast to IP during the transmission of an auxiliary section.

15. The method of claim 14 wherein the allocation tables are sent with a validity period indicating from when to when each list is valid.

16. A method to optimize the transmission of a set of television channels to at least one reception device, the method comprising:
receiving, by a control center, status messages from a plurality of reception devices, each of the reception devices having a device identifier, a broadcast interface and an Internet Protocol (IP) interface, and each of the status messages including a channel identifier identifying a selected channel received via either the broadcast interface or the IP interface;
calculating, by the control center, from the status messages, a cost per channel based at least on a number of reception devices having selected said channel;
allocating, by the control center, the channels having the highest cost to the broadcast transmission center and allocating the other channels to the IP transmission center; and
transmitting, by the control center, a response message to the reception devices, said response message comprising an allocation list describing, for each channel, to which interface said channel was allocated.

17. A control center to optimize the transmission of a set of television channels to at least one reception device, the control center comprising:
a first interface configured for communication with an Internet Protocol (IP) transmission center;
a second interface configured for communication with a broadcast transmission center;
an IP interface; and
a control center circuit connected to the first interface, the second interface and the IP interface, the control center circuit being configured to
receive status messages from a plurality of reception devices, each of the reception devices having a device identifier, a broadcast interface and an IP interface, and each of the status messages including a channel identifier identifying a selected channel received via either the broadcast interface or the IP interface of the reception device;
calculate, from the status messages, a cost per channel based at least on a number of reception devices having selected said channel;
allocate the channels having the highest cost to the broadcast transmission center and allocating the other channels to the IP transmission center; and
transmitting a response message to the reception devices, said response message comprising an allocation list describing, for each channel, to which interface said channel was allocated.
